(19) United States
(12) Patent Application Publication
(10) Pub. No.: US 2003/0065089 A1
(43) Pub. Date: Apr. 3, 2003

(54) Aqueous dispersion in a formulation for floor adhesives

(76) Inventors: Isabelle Betremieux, Beaumontel (FR); Christophe Verge, Beaumontel (FR); Karine Loyen, le Havre (FR); Christian Laurichesse, Bernay (FR)

Correspondence Address: SMITH, GAMBRELL & RUSSELL, LLP, 1850 M STREET, N.W., SUITE 800, WASHINGTON, DC, 20036, US

(21) Appl. No.: 10/182,119

(22) PCT Filed: Jan. 12, 2001
(86) PCT No.: PCT/FR01/00107

(30) Foreign Application Priority Data
Jan. 28, 2000 (FR) 00/01148

(51) Int. Cl. C08K 3/00; C08K 3/20

(52) U.S. Cl. 524/608; 524/599; 524/606

(57) ABSTRACT

The invention describes the use in a formulation for floor adhesives of an aqueous dispersion containing from 5 to 70% by weight of at least one polymer having a glass transition temperature below 0° C. and carrying a ureido functional group.

The dispersions of the invention do not give off volatile organic compounds and, after application, result in crosslinked films having a good tack/cohesion compromise.

The invention relates to the use, in a formulation for floor adhesives which do not give off volatile organic compounds during application, of an aqueous dispersion based on a functional polymer having a glass transition temperature below 0°, and in particular a polymer carrying a ureido functional group.

Floor adhesives according to the invention can be used to fasten various coverings, such as carpets and PVC tiles to a floor consisting, especially, of concrete or plaster.

In general, floor adhesives are obtained by the formulation of an aqueous dispersion of polymer, tackifying resins dissolved in solvents or plasticizers, mineral fillers, a wetting agent, an antifoam and water.

Such a composition gives off volatile organic compounds (VOCs) which may come either from the aqueous dispersion or from the solvents used to dissolve the tackifying resins, or from the tackifying resins themselves.

It has become a major preoccupation to reduce the amount of volatile compounds given off from adhesives when laying floor coverings such as carpets or PVC tiles.

The problem that the invention intends to solve is how to develop an aqueous dispersion having a low VOC content (<1000 ppm) which is a very effective binder for the formulation of floor adhesives with a low VOC content, that is to say those not requiring the use of a solvent during introduction of the tackifying resin.

WO 95/21884 describes adhesive formulations composed of an aqueous dispersion containing a polymer, and fillers not requiring the use of organic solvents, of plasticizers or of tackifying resins. The polymer of the aqueous dispersion is characterized by a glass transition temperature (Tg) below −30° C. and weight-average molar masses greater than 20 000.

U.S. Pat. No. 5,196,468 describes adhesive formulations containing less than 2% of organic compounds having a boiling point below 100° C., comprising an acrylic latex, a tackifying resin, a plasticizer of the monophenyl polyethylene or polypropylene glycol type, and fillers.

The problem remaining to be solved is how to develop a formulation for floor adhesives which does not give off volatile organic compounds but does result, after application, in a film having a satisfactory tack cohesion compromise.

The Applicant has found that the use in an adhesive formulation of a dispersion containing a polymer carrying particular functional monomers, such as ureido monomers, results, after application, in the formation of a crosslinked film having better properties than that of an uncrosslinked film.

It is assumed that this is due to interactions between the ureido functional groups or between the ureido functional groups and the acid comonomers optionally present in the dispersion.

The above remark is valid even if the polymer of the aqueous dispersion has only a small amount of ureido monomers.

The first subject of the present invention is the use, in a formulation for floor adhesives, of an aqueous dispersion containing from 20 to 70% by weight of at least one polymer P1 containing:

from 50 to 99.5% by weight of at least one (meth)acrylic ester A;

from 0.1 to 5% by weight of at least one carboxylic acid B;

from 0 to 20% by weight of at least one unsaturated nitrile C;

from 0 to 30% by weight of at least one vinyl monomer D; and

from 0.5 to 5% by weight of at least one monomer carrying a ureido functional group E.

The (meth)acrylic esters A, usually employed as a mixture, are chosen from the group containing-methyl methacrylate, methyl acrylate, butyl acrylate and 2-ethylhexyl acrylate.

The unsaturated acids B are chosen from the group containing acrylic acid, methacrylic acid and itaconic acid.

The unsaturated nitrites C are chosen from acrylonitrile and its derivatives.

The vinyl monomers D are chosen from the group containing vinyl acetate, vinyl laurate and vinyl versatates.

Moreover, it is preferable, in order to obtain a dispersion with a very low VOC content, to avoid introducing vinyl acetate into the polymer composition as it is well known to those skilled in the art that this is a monomer difficult to remove by conventional postpolymerization reactions.

The functional monomers E are monomers capable of creating interactions between themselves or the acid monomers optionally present. The monomers carrying ureido functional groups are chosen from the group of monomers comprising, especially, ethylimidazolidone (meth)acrylate, ethylimidazolidone (meth)acrylamide and 1-(2-((2-hydroxy-3-(2-propenyloxy)propyl)amino)ethyl)-2-imidazolidone.

The polymer P1 has a glass transition temperature below 0° C., preferably between 0° C. and −30° C. and more preferably between −15° C. and −30° C.

The aqueous dispersion is obtained by the emulsion polymerization of a monomer mixture containing:

from 50 to 99.5% by weight of at least one (meth)acrylic ester A;

from 0.1 to 5% by weight of at least one carboxylic acid B;

from 0 to 20% by weight of at least one unsaturated nitrile C;

from 0 to 30% by weight of at least one vinyl monomer D; and

from 0.5 to 5% by weight of at least one monomer carrying a ureido functional group E.

The polymer is produced by a batch, or preferably semicontinuous, radical emulsion polymerization process, possibly using a seed polymer or a polymer which creates the seed in situ.

In the case of a semicontinuous process, the monomers are introduced into the reactor at a rate such that they are consumed as they are being introduced and such that the heat given off by the polymerization reaction can be removed.

The functional monomer or monomers may be introduced continuously throughout the polymerization process or in a sequenced manner. The preferred method of introduction consists in introducing the functional monomer either at the start or at the end of the polymerization, so that the final polymer consists of macromolecular chains which carry functional monomers and macromolecular chains which are not functionalized. This is one method of modifying the distribution of the crosslinking nodes in the material and of optimizing the distribution of these crosslinking nodes for the purpose of improving the application properties.

In this emulsion polymerization process, the monomers are polymerized at temperatures between 30 and 95° C. in the presence of water-soluble initiators.

The preferred water-soluble initiating systems are ammonium, sodium and potassium persulfates and water-soluble azo derivatives, such as 4,4′-az-obis(4-cyanovaleric acid) or 2,2′-azobis(2-amidinopropane) dihydrochloride. Also recommended are redox systems such as H₂O₂, tert-butyl hydroperoxide or the sodium salt of a mixture of m- and p-diisopropyl benzene hydroperoxide used in the presence of reducing agents such as, for example, sodium formaldehyde sulfoxylate, sodium metabisulfite or ascorbic acid.

The molecular masses of the polymers P1 are optimized, by virtue of the initiating system, to the polymerization temperature. In certain cases, the use of transfer agents, such as dodecylmercaptan, terdodecylmercaptan or mercaptopropionic acid for example, may be useful.

The surfactants used are most often a mixture of anionic and nonionic surfactants chosen, for example, from alkyl sulfates, alkyl ether sulfates, alkylaryl ether sulfates, alkyl sulfonates, alkylaryl sulfonates, diphenylalkyl ether sulfonates, ethoxylated fatty alcohols, ethoxylated alkylaryls, etc.

The final solids content of these aqueous dispersions is between 20 and 70% and preferably between 40 and 65%.

These aqueous dispersions can then be formulated in formulations containing no solvent; they therefore result in VOC-free floor adhesives having properties equivalent to those containing solvents. These dispersions may furthermore be formulated in the presence of resins containing rosin or rosin derivatives such as, for example, rosin esters or hydrogenated rosin.

The manufacturing and evaluation methods are described in the examples.

The following examples illustrate the invention without limiting the scope thereof.

### EXAMPLES

### Examples I

### Manufacture of the Aqueous Dispersions

### Example I-a

243.4 g of water were introduced into a 3-liter jacketed glass reactor and heated to 67° C., the reactor being fitted with an anchor-type mechanical stirrer. Once the temperature was reached, 23.1 g of the monomer pre-emulsion, 3.3 g of the initiator solution 1 and 2.4 g of the activator solution 1 were added batchwise.

Five minutes later, the rest of the monomer pre-emulsion together with the rest of the initiator solution 1 and activator solution 1 were poured in separately over 5 hours, while maintaining the temperature at 67° C.

To remove the residual monomers, a postpolymerization step was carried out with the initiator solution 2 and the activator solution 2.

| Monomer pre-emulsion: | | |
|---|---|---|
| Water | 416.7 | g |
| 30% ethoxylated fatty alcohol sulfate | 33.3 | g |
| in water | | |
| 65% ethoxylated fatty alcohol in water | 28.7 | g |
| Methacrylic acid | 56.0 | g |
| Acrylonitrile | 126.0 | g |
| Butyl acrylate | 1218.0 | g |
| Initiator solution 1: | | |
| Water | 37.8 | g |
| Ammonium persulfate | 4.2 | g |
| Activator solution 1: | | |
| Water | 37.8 | g |
| Sodium metabisulfite | 4.2 | g |
| Initiator solution 2: | | |
| Water | 18.9 | g |
| Tert-butyl hydroperoxide | 2.8 | g |
| Activator solution 2: | | |
| Water | 46.3 | g |
| Sodium formaldehyde sulfoxylate | 1.9 | g |

### Example I-b

The latex obtained according to this example was produced in the same way as in Example I-a, only the composition of the monomer pre-emulsion changing.

| Monomer pre-emulsion: | | |
|---|---|---|
| Water | 416.7 | g |
| 30% ethoxylated fatty alcohol sulfate | 33.3 | g |
| in water | | |
| 65% ethoxylated fatty alcohol in water | 28.7 | g |
| Methacrylic acid | 56.0 | g |
| Ethylureido methacrylate | 7.0 | g |
| Methyl methacrylate | 19.0 | g |
| Acrylonitrile | 124.0 | g |
| Butyl acrylate | 1204.0 | g |

### Example I-c

243.4 g of water were introduced into a 3-liter jacketed glass reactor and heated to 67° C., the reactor being fitted with an anchor-type mechanical stirrer. Once the temperature was reached, 23.1 g of the monomer pre-emulsion 1, 3.3 g of the initiator solution 1 and 2.4 g of the activator solution 1 were added batchwise.

Five minutes later, the rest of the monomer pre-emulsion 1 was poured in over 2 hours 30 minutes. After pouring in the pre-emulsion 1, the operation of pouring in the monomer pre-emulsion 2 was started and it lasted 2 hours 30 minutes. At the same time, the initiator solution 1 and the activator solution 1 were introduced separately over 5 hours.

To remove the residual monomers, a postpolymerization step was carried out with the initiator solution 2 and the activator solution 2.

| Monomer pre-emulsion 1: | | |
|---|---|---|
| Water | 208.3 | g |
| 30% ethoxylated fatty alcohol sulfate | 15.2 | g |
| in water | | |
| 65% ethoxylated fatty alcohol in water | 14.4 | g |
| Methacrylic acid | 27.4 | g |
| Ethylureido methacrylate | 7.0 | g |
| Methyl methacrylate | 21.0 | g |
| Acrylonitrile | 54.8 | g |
| Butyl acrylate | 589.7 | g |
| Monomer pre-emulsion 2: | | |
| Water | 208.3 | g |
| 30% ethoxylated fatty alcohol sulfate | 15.2 | g |
| in water | | |
| 65% ethoxylated fatty alcohol in water | 14.4 | g |
| Methacrylic acid | 28.6 | g |
| Acrylonitrile | 57.1 | g |
| Butyl acrylate | 614.3 | g |
| Initiator solution 1: | | |
| Water | 37.8 | g |
| Ammonium persulfate | 4.2 | g |
| Activator solution 1: | | |
| Water | 37.8 | g |
| Sodium metabisulfite | 4.2 | g |
| Initiator solution 2: | | |
| Water | 18.9 | g |
| Tert-butyl hydroperoxide | 2.8 | g |
| Activator solution 2: | | |
| Water | 46.3 | g |
| Sodium formaldehyde sulfoxylate | 1.9 | g |

### Example I-d

### Trial 4510-056

The latex obtained in this example was produced in the same way as in Example I-c, only the order of introducing the pre-emulsion 1 and the pre-emulsion 2 being reversed.

Table summarizing the characteristics of the aqueous
dispersions obtained in Example I

| | Example | Example | Example | Example |
|---|---|---|---|---|
| Reference | I-a | I-b | I-c | I-d |
| Characteristics | | | | |
| Solids content (%) | 61.3 | 61.0 | 61.2 | 60.9 |
| pH | 6.2 | 6.3 | 6.2 | 6.2 |
| Viscosity (mPa · s) | 2500 | 700 | 3600 | 780 |

### Examples II

### Floor Adhesive Formulations

The latices obtained above were evaluated in an adhesive formulation intended for adhesively bonding floor coverings.

Manufacture:

The latex was poured into a beaker.

The antifoam, the preservative, the dispersing agent and the filler were then put into the latex with gentle stirring.

After stirring for 10 minutes, the tackifying resin solution preheated to 40° C. was slowly added to the emulsion and homogenized for about 30 minutes.

The filler of calcium carbonate type was then added to the mixture, with stirring, and homogenized for about 60 minutes.

The final viscosity of the product was adjusted to be between 20 000 and 60 000 mPa.s using a thickener of the polyacrylate type.

The composition of the adhesives manufactured is given in the table below:

Composition of the adhesives

| Components | 543 | 547 | 548 | 551 |
|---|---|---|---|---|
| Example I-a (53) | 34 | | | |
| Example I-b (54) | | 34 | | |
| Example I-c (55) | | | 34 | |
| Example I-d (56) | | | | 34 |
| Thickener | 1 | 0.3 | | 0.75 |
| Antifoam | 0.2 | 0.2 | 0.2 | 0.2 |
| Preservative | 0.2 | 0.2 | 0.2 | 0.2 |
| Resin syrup | 25 | 25 | 25 | 25 |
| Filler | 30 | 30 | 30 | 30 |

Application:

Determination of the Setting Rate:

Equipment Used:

AGLOPLAN (fiber-cement without asbestos) board;

Floor-covering test specimens having the dimensions of 10×8 cm;

2 kg pressing weight mass having the dimensions of 10×8 cm;

7.5 cm diameter cylinders.

Operating Method:

The floor-covering test specimens were placed in the cylinder for 48 hours before the test so as to obtain a test specimen of curved shape (simulation of a roll of floor covering).

The adhesive was deposited on an AGLOPLAN board using a serrated spatula (the amount deposited was about 350 g/m²)

After an application-to-bonding time of 5 minutes, the floor covering specimens were applied to the adhesive at regular time intervals (every 5 minutes) and then pressed with the 2 kg weight for 10 s.

The weight was then removed and it was noted whether or not the edges of the test specimen lifted up. If the test specimen then lifted up, the weight was applied again for 10 s and so on until the edges did not lift up.

The time required for the test specimens to remain properly in contact with the substrate and no longer lift up was recorded.

Determination of the Open Time:

The floor-covering test specimens were applied in the same way as above every 5 minutes up to one hour. The bonds thus formed were stabilized for 24 h before evaluation.

This evaluation was carried out manually by tearing the specimens from the substrate. In this way, the maximum time during which the adhesive has retained sufficient adhesion to bond the floor covering was determined.

Results of the Tests:

Results of the evaluation

| TESTS | 543 | 547 | 548 | 551 |
|---|---|---|---|---|
| Setting time | 20* | 15* | 15 | 20* |
| (in minutes) | | | | |
| Open time | 60 | 30 | 45 | 40 |
| (in minutes) | | | | |

*The edges of the carpet test specimens lifted up after a few hours

1. Use, in a formulation for floor adhesives, of an aqueous dispersion containing from 20 to 70% by weight of at least one polymer P1 containing:
from 50 to 99.5% by weight of at least one (meth)acrylic ester A;
from 0.1 to 5% by weight of at least one carboxylic acid B;
from 0 to 20% by weight of at least one unsaturated nitrile C;
from 0 to 30% by weight of at least one vinyl monomer D; and
from 0.5 to 5% by weight of at least one monomer carrying a ureido functional group E.

2. The use as claimed in claim 1, characterized in that P1 has a glass transition temperature below 0° C.

3. The use as claimed in claim 2, characterized in that P1 has a glass transition temperature between −30 and −15° C.

4. The use as claimed in one of the preceding claims, characterized in that A is chosen from the group containing methyl methacrylate, methyl acrylate, butyl acrylate and 2-ethylhexyl acrylate.

5. The use as claimed in one of the preceding claims, characterized in that B is chosen from the group containing acrylic acid, methacrylic acid and itaconic acid.

6. The use as claimed in one of the preceding claims, characterized in that C is chosen from acrylonitrile and its derivatives.

7. The use as claimed in one of the preceding claims, characterized in that D is chosen from the group containing vinyl acetate, vinyl laurate and vinyl versatates.

8. The use as claimed in one of the preceding claims, characterized in that E is chosen from monomers carrying a ureido functional group, such as ethylimidazolidone (meth)acrylate, ethylimidazolidone (meth)acrylamide and 1-(2-((2-hydroxy-3-(2-propenyloxy)propyl)amino)ethyl)-2-imidazolidone.

9. The use as claimed in one of the preceding claims, characterized in that P1 is obtained by the emulsion polymerization of a monomer mixture containing:
from 50 to 99.5% by weight of at least one (meth)acrylic ester A;
from 0.1 to 5% by weight of at least one carboxylic acid B;
from 0 to 20% by weight of at least one unsaturated nitrile C;
from 0 to 30% by weight of at least one vinyl monomer D; and
from 0.5 to 5% by weight of at least one monomer carrying a ureido functional group E.
